(19) United States
(12) Patent Application Publication
(10) Pub. No.: US 2015/0324281 A1
(43) Pub. Date: Nov. 12, 2015

(54) SYSTEM AND METHOD OF IMPLEMENTING AN OBJECT STORAGE DEVICE ON A COMPUTER MAIN MEMORY SYSTEM

(71) Applicant: Diablo Technologies Inc., Ottawa (CA)

(72) Inventors: Michael L. Takefman, Nepean (CA); Bart Trojanowski, Ottawa (CA); Maher Amer, Nepean (CA)

(73) Assignee: Diablo Technologies Inc., Ottawa (CA)

(21) Appl. No.: 14/271,773

(22) Filed: May 7, 2014

(51) Int. Cl. G06F 12/02

(52) U.S. Cl. CPC G06F 12/0246; G06F 2212/7208

(57) ABSTRACT

A system and method for implementing an object storage device is disclosed. According to one embodiment, the system includes a first controller configured to interface with a main memory controller of a computer system to receive a data object and a first request for storing the data object, the first request including a key value. The system also includes a second controller configured to: allocate memory in one or more non-volatile memory storage units for storing the data object, store the data object in the allocated memory, and maintain an association between the key value and allocated memory.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### RELATED FIELD

The present disclosure relates in general to object storage, and in particular, to implementing an object storage device on a computer main memory system

### BACKGROUND

Object storage, or object-based storage, generally refers to an approach for storing and retrieving data in discrete units, called objects. An object store generally refers to a type of database where variable sized objects are stored and referenced using a key. Object storage differs from traditional file-based storage in several basic aspects. File-based storage generally stores data as a hierarchy of files. This makes file-based storage generally more suited for human users because of their inclination towards and perception of hierarchal organization.

Object storage, on the other hand, is more suited for big data applications (e.g., cloud storage and object-oriented programming) that manage billions of data objects. Both a file and an object contain data and have associated metadata. However, objects, unlike files, are not organized in a hierarchy. Instead, objects are stored in a flat address space and are retrieved using unique IDs or keys. This allows an object storage device to scale much more easily than a file-based storage device by adding more physical memory. Object storage also requires less metadata than required by the traditional file system, and thus, reduces the overhead of managing metadata by storing the metadata with the object.

Object storage also differs from block-level data storage in that data may be stored and retrieved without specifying the physical location where the data is stored. The object storage approach may be illustrated by analogizing to valet parking. When a customer hands off his car and key to the valet, he receives a receipt. The customer does not need to know where his car will be parked and whether the car will be moved around while in storage. The customer only needs his receipt to retrieve his car. Similarly, when an object is stored in an object storage device, it is associated with a key. The key is generally a set of bytes that uniquely identify each object. The size of the key generally depends on the application and hence may vary from database to database. Based on the key alone, the object may be retrieved without specifying the physical location of the data. In contrast, block-level data storage generally requires a physical address specifying the data's physical location (e.g., chip address, bank address, block address, and row address) in order to retrieve the data.

An object storage device may be implemented using a combination of software and hardware components. Traditionally, a large object storage device (OSD) interfaces with a computer system via the computer system's I/O bus. That is, although a traditional OSD may load its hash table or tree into the computer system's main memory (e.g., RAM) to facilitate key searching, the data objects in the OSD are accessed via the computer system's I/O bus. Interfacing to the computer system via the I/O bus limits the OSD's access speed due to the lower bandwidths and higher latencies, supported by the I/O bus. Although for a smaller database an in-memory OSD may be implemented, which is faster than an OSD on the I/O bus, such in-memory OSDs generally cannot scale in capacity. Therefore, there exists a need for a system and method of implementing an object storage device on a computer main memory system to provide enhanced I/O capabilities, capacity, and performance.

### SUMMARY

A system and method for implementing an object storage device is disclosed. According to one embodiment, the system includes a first controller configured to interface with a main memory controller of a computer system to receive a data object and a first request for storing the data object. The first request includes a key value. The system also includes a second controller configured to: (1) allocate memory in one or more non-volatile memory storage units for storing the data object, (2) store the data object in the allocated memory, and (3) maintain an association between the key value and allocated memory.

A method for implementing an object storage device is also disclosed. According to one embodiment, the method includes: interfacing with a main memory controller of a computer system to receive a first request for storing a data object, the first request including a key value; receiving the data object from the computer system; allocating memory in one or more non-volatile memory storage units; storing the data object in the allocated memory; and maintaining an association between the key value and where the data object is stored.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of the present disclosure.

### BRIEF DESCRIPTION OF THE DRAWING

The accompanying drawings, which are included as part of the present specification, illustrate various embodiments and together with the general description given above, and the detailed description of the various embodiments given below serve to explain and teach the principles described herein.

FIG. 1 illustrates a block diagram of an exemplary computer architecture implementing an OSD via the main memory bus, according to one embodiment;

FIG. 2 illustrates a block diagram of an exemplary implementation of an OSD on a computer system's main memory, according to one embodiment;

FIG. 3 illustrates a block diagram of another exemplary implementation of an OSD on a computer system's main memory, according to one embodiment;

FIG. 4 illustrates a block diagram of exemplary tables maintained by an object store implementing a lookup engine and an SSD controller, according to one embodiment;

FIG. 5 illustrates a block diagram of exemplary tables of an object store that uses an SSD controller to maintain a free LBA table, according to one embodiment;

FIG. 6 illustrates a block diagram of exemplary tables of an object store that uses an SSD controller to manage objects, according to one embodiment; and

FIG. 7 illustrates an exemplary object being stored in two contiguous flash pages, according to one embodiment.

The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

### DETAILED DESCRIPTION

Each of the features and teachings disclosed herein can be utilized separately or in conjunction with other features and teachings to provide a system and method of implementing an object storage device on a computer main memory system. Representative examples utilizing many of these additional features and teachings, both separately and in combination, are described in further detail with reference to the attached figures. This detailed description is merely intended to teach a person of skill in the art further details for practicing aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing,” “computing,” “calculating,” “determining,” “displaying,” or the like, refer to the actions and processes of a computer system, or a similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

The present disclosure describes a system and method of implementing an object storage device on a computer main memory system and relates to co-pending and commonly-assigned U.S. patent application Ser. No. 13/303,048 entitled “System and Method of Interfacing Co-processors and Input/Output Devices via a Main Memory System,” incorporated herein by reference. U.S. patent application Ser. No. 13/303,048 describes a system and method for implementing co-processors and/or I/O (hereafter “CPIO”) devices on a computer main memory system to provide enhanced I/O capabilities and performance.

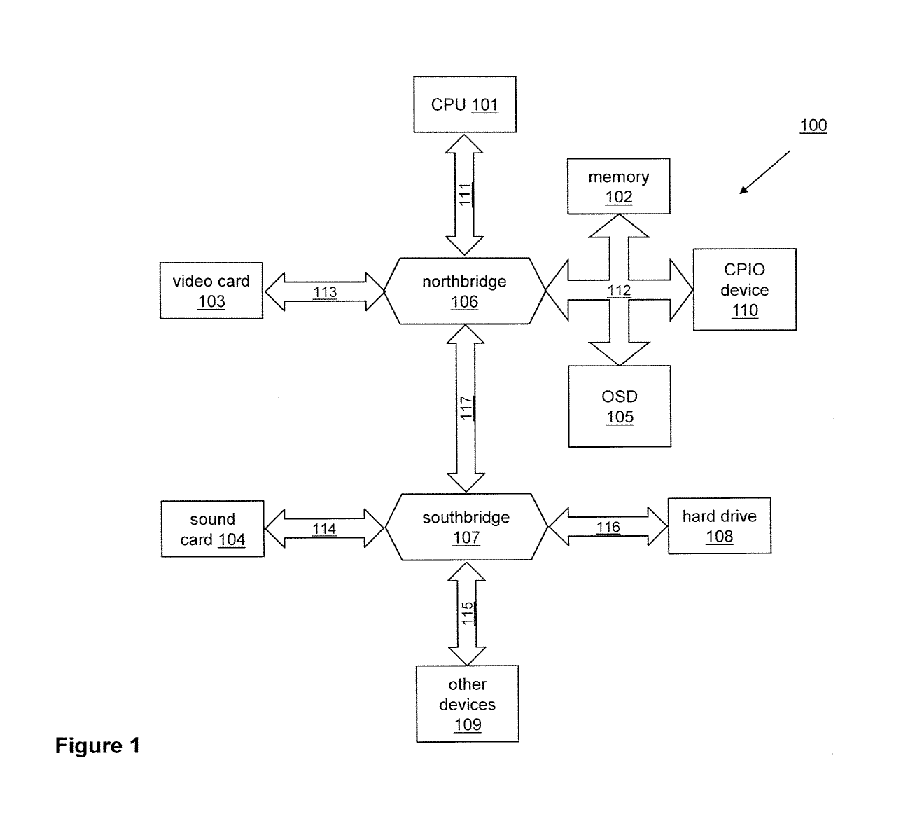

FIG. 1 illustrates a block diagram of an exemplary computer architecture implementing an OSD via the main memory bus, according to one embodiment. The computer system 100 includes a central processing unit (CPU) 101, a main memory unit (e.g., DRAM) 102, and CPIO devices including a video card 103, a sound card 104, a hard drive 108, an OSD 105, and any generic CPIO device 110. These components are connected together via buses on a motherboard (not shown). As illustrated, CPU 101, main memory unit 102, and video card 103 are connected via a front-side bus (FSB) 111, a main memory bus 112, and a peripheral component interconnect express (PCIe) bus 113, respectively, to a northbridge 106. The northbridge 106 generally refers to a chip in a chipset of the motherboard that connects high speed buses.

Slower buses, including the PCI bus 114, the universal serial bus (USB) 115, and the serial advanced technology attachment (SATA) bus 116 are usually connected to a southbridge 107. The southbridge 107 generally refers to another chip in the chipset that is connected to the northbridge 106 via a direct media interface (DMI) bus 117. The southbridge 107 manages the information traffic between CPIO devices that are connected via the slower buses. For example, the sound card 104 typically connects to the system 100 via the PCI bus 114. Storage drives, such as the hard drive 108, typically connect via the SATA bus 116. A variety of other devices 109, ranging from keyboards to mp3 music players, may connect to the system 100 via the USB 115.

Similar to the main memory unit 102 (e.g., DRAM), the OSD 105 and generic CPIO device 110 connect to a memory controller in the northbridge 106 via the main memory bus 112. For example, the OSD 105 may be inserted into a dual in-line memory module (DIMM) memory slot. Because the main memory bus 112 generally supports higher bandwidths (e.g., compared to the SATA bus 116), the exemplary computer architecture of FIG. 1 connecting the OSD 105 to the main memory bus eliminates or alleviates I/O bottlenecks that would otherwise limit the I/O performance of the OSD 105. While FIG. 1 illustrates each of the block components as discrete components, it is contemplated that some of the components may be combined or integrated with one or more other components. For example, the CPUs produced by INTEL® may include a northbridge or southbridge as part of the CPU.

According to one embodiment, the presently disclosed OSD includes a lookup engine that maintains a searchable list of the currently stored objects, related object metadata, and an object storage element that is configured to store object data. The OSD supports operations for retrieving an object from the storage element if it exists (e.g., a GET operation), storing a new object into the storage element or replacing an existing object (e.g., a PUT operation), and discarding an object from the storage element (e.g., a DELETE operation). The OSD may also support an operation that tests the existence of an object (e.g., an EXISTS operation) and an atomic replace operation (e.g., an EXCHANGE operation). A computer system implementing the OSD may access the OSD via an application programming interface (API). For example, an exemplary API may provide the following functions for accessing the OSD:

| | |
|---|---|
| • | void * get_obj( key_type obj_key, void *obj_ptr, int *size) |
| | // This function searches the object store for an object whose key matches |
| | // obj_key and copies or returns the object into a location corresponding to obj_ptr. If |
| | // an object is returned, the size of the object is also returned in the size parameter. |
| | // The function returns NULL if the object is not found. Otherwise it returns obj_ptr |
| • | int put_obj( key_type obj_key, int obj_size, void *obj_ptr) |
| | // This function puts an object into the object store and associates the object with |
| | // obj_key. If the object is already in the store, it is replaced. The function returns |
| | // NULL on success or an error value if there is an issue. |
| • | int delete_obj( key_type obj_key) |
| | // This function removes an object from the object store. The function returns NULL |
| | // on success or an error value if there is an issue. |
| • | bool exists_obj ( key_type obj_key, int *size) |
| | // This function tests an object's existence and returns a Boolean to indicate this |
| | // state. If an object exists, the size parameter is updated with the size of the object. |
| • | void *exchange_obj( key_type obj_key, int *old_obj_size, void *old_obj_ptr, int |
| | new_obj_size, void *new_obj_ptr ) |
| | // This function atomically replaces an object assigned to a key with a new object. |
| | // It operates like a get_obj( ) followed by a put_obj( ), but done in a race-free manner |
| | // so other users of the datastore only observe the old object or the new object. If no |
| | // object exists under the obj_key, NULL is returned. If an object is returned, the |
| | // old_obj_size parameter is set to the old object size. |

According to one embodiment, the lookup engine facilitates the retrieval of object data (from an object storage element) associated with a key. The lookup engine searches a list of the currently stored objects for the key and, if found, returns an object storage pointer to the object data stored in the storage element. The lookup engine may be implemented using various methods that are known in the art, including but not limited to using content-addressable memory (CAMs), ternary CAMs, and memory-based (e.g., DRAM/SRAM) data structures such as hash tables and trees.

A CAM generally refers to a hardware implementation of an associative array and operates as a hardware search engine for matching a key with its associated value. In the case of a lookup engine implementing a CAM, the key may be associated with an address pointer to where object data and metadata are stored. Thus, when a key is provided to the CAM, the CAM matches the key to the keys stored in the CAM. If a match is found, the CAM returns an address pointer that is associated with the stored key. A CAM generally includes semiconductor memory (e.g., SRAM) and bitwise comparison circuitry (for each key storage element) to enable a search operation to complete in a single clock cycle. There are generally two types of CAMs; binary CAMs and ternary CAMs. A binary CAM stores key values as strings of binary bits (i.e., 0 or 1) while a ternary CAM stores key values as strings of binary bits and a “don't care” bit (i.e., 0, 1, or X). The inclusion of a “don't care” bit X, for example, in the stored key 10010X allows either key 100101 or key 100100, to match the stored key.

A hash table generally refers to a data structure for implementing an associative array that maps keys to values. A hash table or tree uses a hash function to compute an index into an array of elements from which an associated value may be found. Thus, unlike key matching for a CAM, key matching for a hash table is performed algorithmically. A hash table or tree is a data structure for implementing an associative array that associates keys to tree nodes and represents a binary tree in which a recursive or iterative process may be used to search its nodes for a given key. A hash table or tree for a lookup engine may include one or more table entries with a field for a key, a field for an object storage pointer, and a field for the size of an object.

The object storage element of the present object store may be implemented using various technologies, including but not limited to DRAM, non-volatile (e.g., flash) memory, and an attached non-volatile storage method (e.g., SSD, PCIe-SSD, and TeraDIMM as described in U.S. patent application Ser. No. 13/303,048). Depending on the type of storage technology implemented, it may be necessary for the object store to maintain a data structure to link together storage blocks to form the object. For example, if a storage method maintains a sector size of 512 bytes and an object is 1 megabyte, then an object comprises 2048 storage sectors, and sector identifiers may be stored in the data structure. Additionally, if the storage method maintains a large sector size, then for objects smaller than one sector, no additional data structure may be necessary. However, in this example, there may be a large amount of wasted storage space when objects are significantly smaller than the sector size. Exemplary implementations of data structures for linking together storage blocks include, but are not limited to: (1) page tables for a DRAM-based object storage element, (2) flash translation layer (FTL) tables for a flash-based object storage element, (3) a file system for a hard-disk-based object storage element, and (4) metadata linked lists for either a flash-based or hard-disk-based object storage element.

If an OSD uses a standard SSD to store the object data, an OSD controller may implement various methods to manage the use of the SSD logical block address (LBA) space. According to one embodiment, the OSD controller maintains a list of LBA objects in a DRAM. This allows the OSD controller to know the exact location of all parts of an object.

According to still another embodiment, the OSD controller may form a linked list where the LBA of the next block is stored as data or metadata in the current block. Under this implementation, the access to the object is serialized. According to yet another embodiment, the OSD controller may store the list of LBAs in one or more pointer LBA blocks. This implementation improves the parallelism of the previous method (i.e., forming a linked list where the LBA of the next block is stored as data or metadata in the current block) at the cost of some additional block storage space and some additional read/write operations.

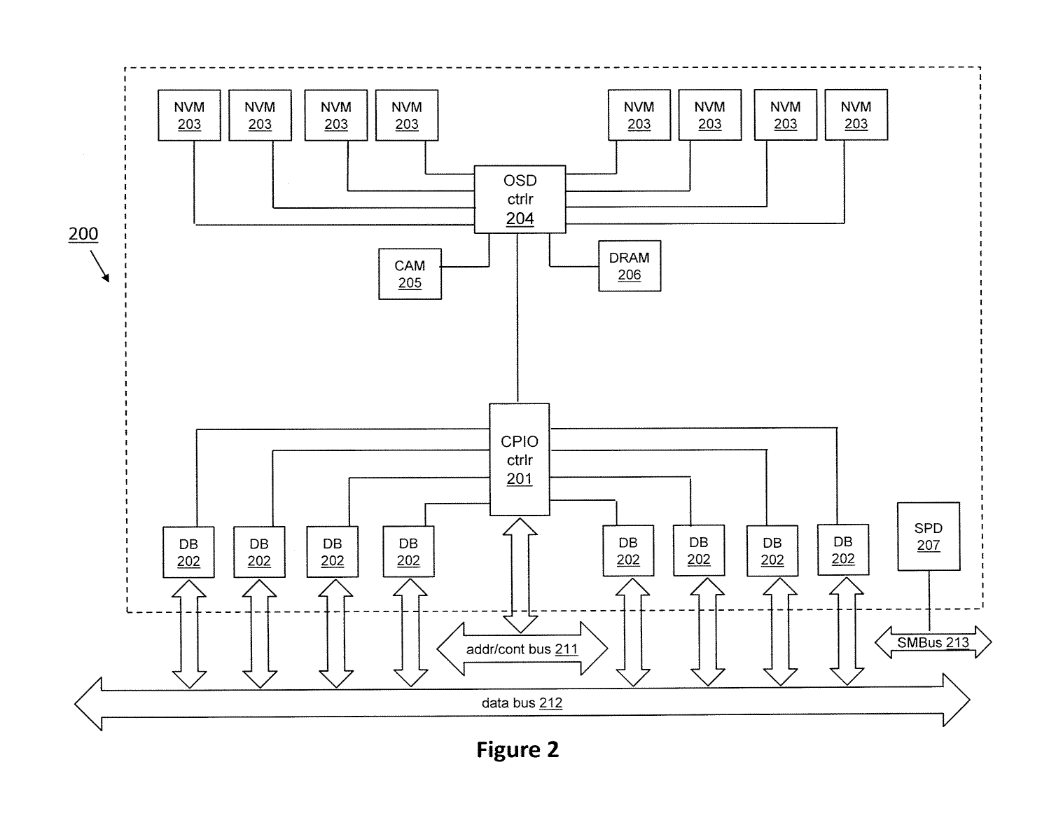

FIG. 2 illustrates a block diagram of an exemplary implementation of an OSD on a computer system's main memory, according to one embodiment. The OSD 200 is configured to interface to the computer system's main memory controller and includes a CPIO controller 201, a number of data buffer devices 202, a rank of non-volatile memory (NVM) devices 203, an OSD controller 204, a CAM 205, a DRAM 206, and an SPD (serial presence detect) 207. The CPIO controller 201 provides a memory mapped interface so that a software driver can control the OSD. The CPIO controller 201 also includes control circuitry for the data buffer devices 202 and an interface (e.g., SATA, PCIe, etc.) to the OSD controller 204. The SPD 207 stores information about the OSD 200, such as its size (e.g., number of ranks of memory), data width, manufacturer, speed, and voltage and provides the information, and may be accessed via the SMBus (system management bus) 213. The DRAM 206 stores table structures such as an object's LBA list that provides the OSD controller 204 the locations of all parts of an object.

The OSD controller 204 operates as a lookup engine for a given key received from the computer system, such as via the data bus 212. The CAM 205 stores a list of the currently stored objects. When the OSD controller 204 provides the key to the CAM 205, the CAM 205 matches the key to its list of currently stored objects. If a match is found, the CAM 205 returns to the OSD controller 204 an object storage pointer to the LBA list in the DRAM 206, which contains the locations of the associated object data stored in the NVM devices 203. The OSD controller 204 also functions as an SSD controller for accessing (e.g., reading, writing, erasing) data in the NVM devices 203. The OSD 200 connects to the address/control bus 211 via the CPIO controller 201 and the main memory bus 212 via the OSD's on-DIMM memory bus and data buffer devices 203. According to one embodiment, the on-DIMM memory bus connects directly to the main memory bus 212 without going through data buffer devices. According to one embodiment, the OSD controller 204 is created by repurposing an existing SSD controller that is implemented on a programmable logic device (e.g., FPGA or microprocessor). Because the OSD 200 does not include a rank of DRAM devices, it provides more room for NVM devices. However, BIOS changes may need to be implemented to bypass a memory test at BIOS boot (e.g., disable the memory test).

The BIOS is a set of firmware instructions that is run by the computer system to set up the hardware and to boot into an operating system when it first powers on. After the computer system powers on, the BIOS accesses the SPD 207 via the SMBus 213 to determine the number of ranks of memory in the OSD 200. The BIOS then typically performs a memory test on each rank in the OSD 200. The OSD 200 may fail the memory test because the test expects DRAM-speed memory to respond to its read and write operations during the test. Although the OSD 200 may respond to all memory addresses at speed, it generally aliases memory words. This aliasing may be detected by the memory test as a bad memory word.

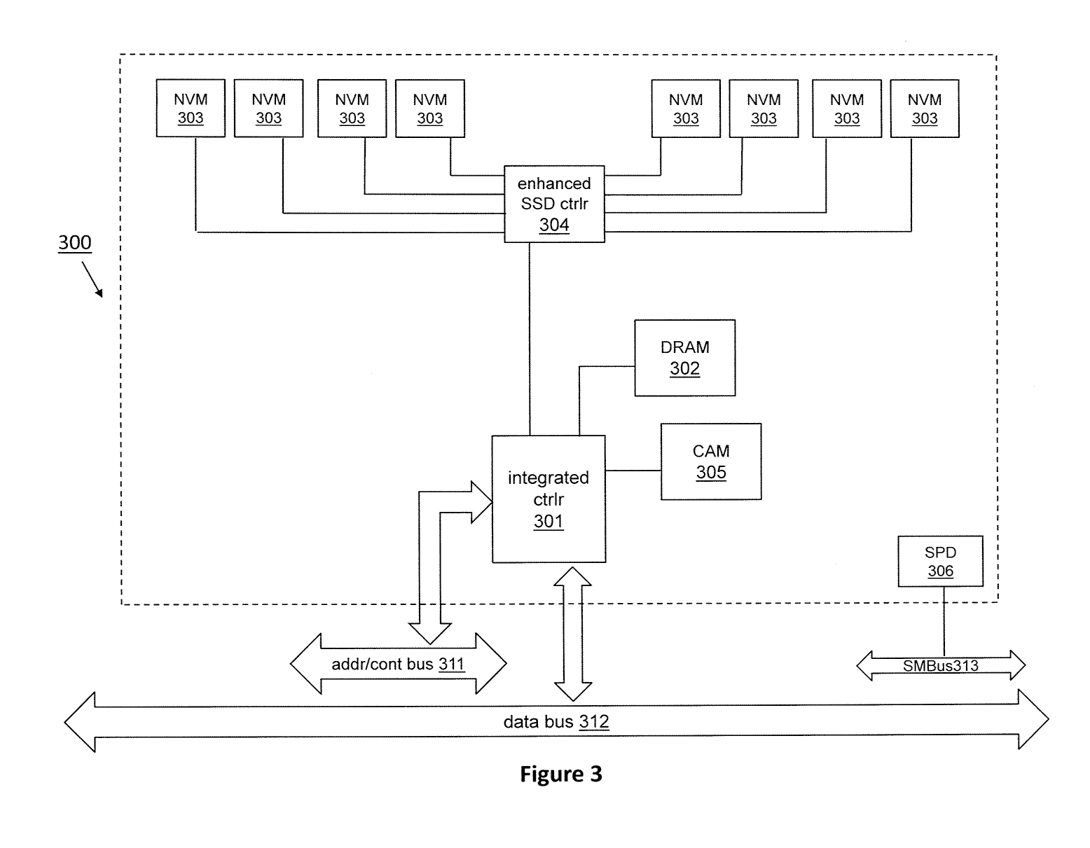

FIG. 3 illustrates a block diagram of another exemplary implementation of an OSD on a computer system's main memory, according to one embodiment. The OSD 300 includes an integrated memory controller 301, a DRAM 302, NVM devices 303, an enhanced SSD controller 304, a CAM 305, and an SPD 306. The integrated controller 301 integrates the functionality of a CPIO controller (e.g., CPIO controller 201) and an object store look up engine. The CAM 305 stores a list of the currently stored objects. When the integrated controller 301 provides a key (received from the computer system, such as via the data bus 312) to the CAM 305, the CAM 305 matches the key to its list of currently stored objects. If a match is found, the CAM 305 returns to the integrated controller 301 an object storage pointer to the LBA list in the DRAM 302, which contains the locations of the associated object data stored in the NVM devices 303. The integrated controller 301 communicates with an enhanced SSD controller 304 to access (e.g., read, write, erase) the object data stored in the NVM devices 303. The integrated controller 301 connects to both the address/control bus 311 and data bus 312. The SPD 306 may be accessed via the SMBus 313. While FIGS. 2 and 3 illustrate each of the block components as discrete components, it is contemplated that some of the components may be combined or integrated with one or more other components. For example, it is contemplated that CPIO controller 201 and OSD controller 204 may be combined into a single controller. Similarly, integrated controller 301 and SSD controller 304 may be combined into a single controller. Other component combinations are contemplated and within the scope of the present disclosure.

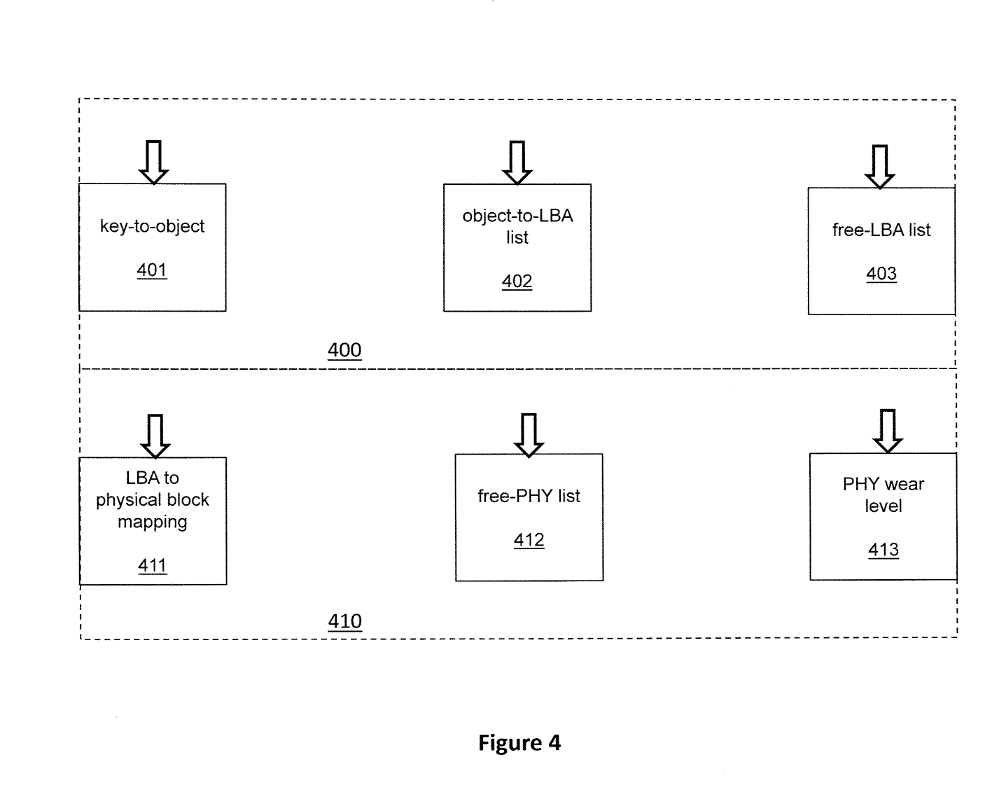

FIG. 4 illustrates a block diagram of exemplary tables maintained by an object store implementing a lookup engine and an SSD controller, according to one embodiment. A lookup engine 400 maintains: (1) a key-to-object table 401 that associates a unique key to an object along with metadata in the object store, (2) an object-to-LBA list table 402 that associates an object to a list of LBAs that correspond to where various parts of the object and metadata are stored, and (3) a free-LBA table 403 containing the allocation information for the LBAs of an SSD. The lookup engine 400 maintains tables 401-403 to support the object store's operations such as get, put and delete. An SSD controller 410 maintains a mapping (411) of LBAs to physical blocks, a list (412) of free physical blocks, and a wear-level table 413 that tracks memory block usage to enable optimization of the SDD's lifetime, such as by equalizing wear among all the memory blocks.

An enhanced SSD refers to a change in the standard SSD capabilities or API. According to one embodiment, an SSD's FTL is optimized to improve performance of the object store. For example, sometimes the advertised sector size of an SSD may be different from the inherent sector size of the underlying flash technology. Legacy file systems may require 512 B or 4 KB sectors while a flash device is organized in 16 KB (or even 32 KB) sectors. A design trade-off may be made to accept a minimum object size to be the same as the inherent sector size in order to make the FTL more efficient due to the lack of multiple LBAs per flash sector.

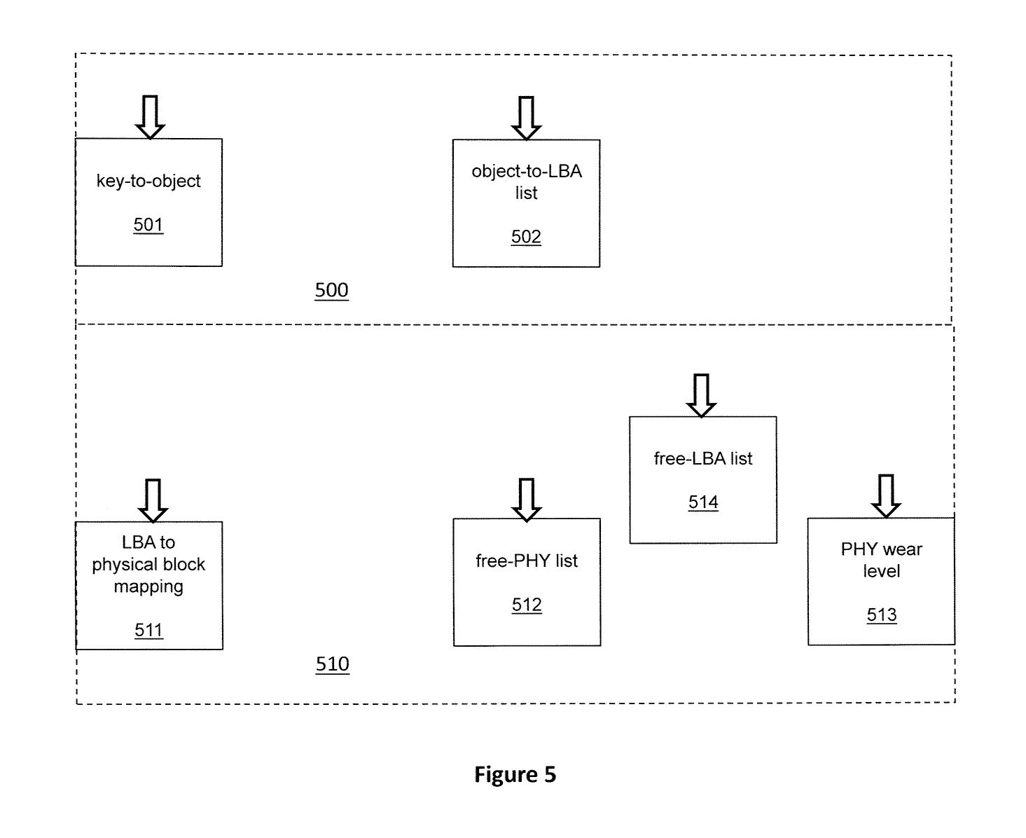

Increasing the size of the sectors also allows tables in the FTL to shrink and additional tables to be included without increasing the size of DRAM for storing the tables. FIG. 5 illustrates a block diagram of exemplary tables of an object store that uses an SSD controller to maintain a free LBA table, according to one embodiment. The object store implements a lookup engine 500 that maintains: (1) a key-to-object table 501 that associates a unique key to an object along with metadata in the object store and (2) an object-to-LBA list table 502 that associates an object to a list of LBAs that correspond to where various parts of the object and metadata are stored. The object store also implements an SSD controller 510 that maintains a mapping (511) of LBAs to physical blocks, a list (512) of free physical blocks, and a wear-level table 513. In contrast with the embodiment shown in FIG. 4, the SSD controller 510 maintains a free-LBA table 503 and the lookup engine 500 does not.

According to one embodiment, the FTL assists in the assignment of LBAs to objects. According to another embodiment, the FTL may be modified to directly support the storing of objects rather than just the management of LBA to physical block address (PBA).

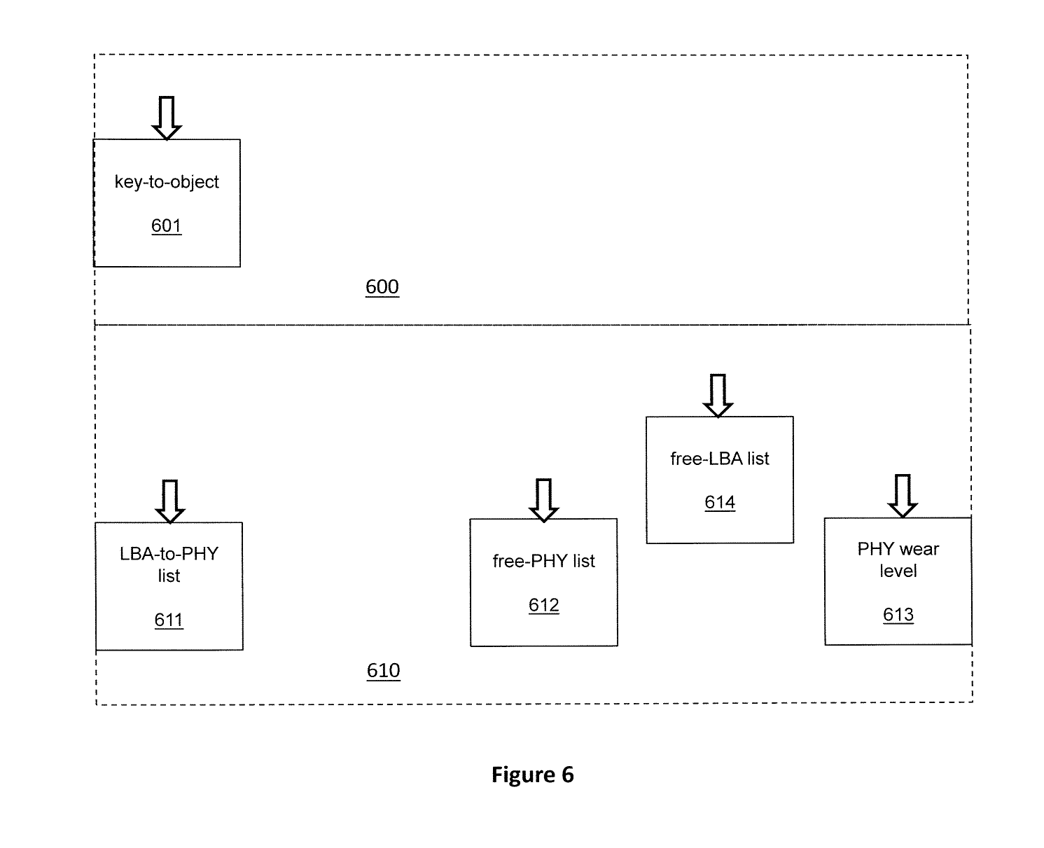

FIG. 6 illustrates a block diagram of exemplary tables of an object store that uses an SSD controller to manage objects, according to one embodiment. The object store implements a lookup engine 600 that maintains a key-to-object table 601 that associates a unique key to an LBA along with metadata in an enhanced SSD. The object store also implements an SSD controller 610 that maintains an LBA-to-PHY list 611, a list (612) of free physical blocks, a wear-level table 613, and a free-LBA table 614. In contrast to the embodiment shown in FIG. 5, the LBA-to-PHY list 611 is a 1:N list where a single LBA is mapped to 1 or more physical blocks (depending on the size of the object). This mapping effectively combines two tables (e.g., tables 502 and 511). Thus, in the embodiment of FIG. 6, the LBAs are object identifiers.

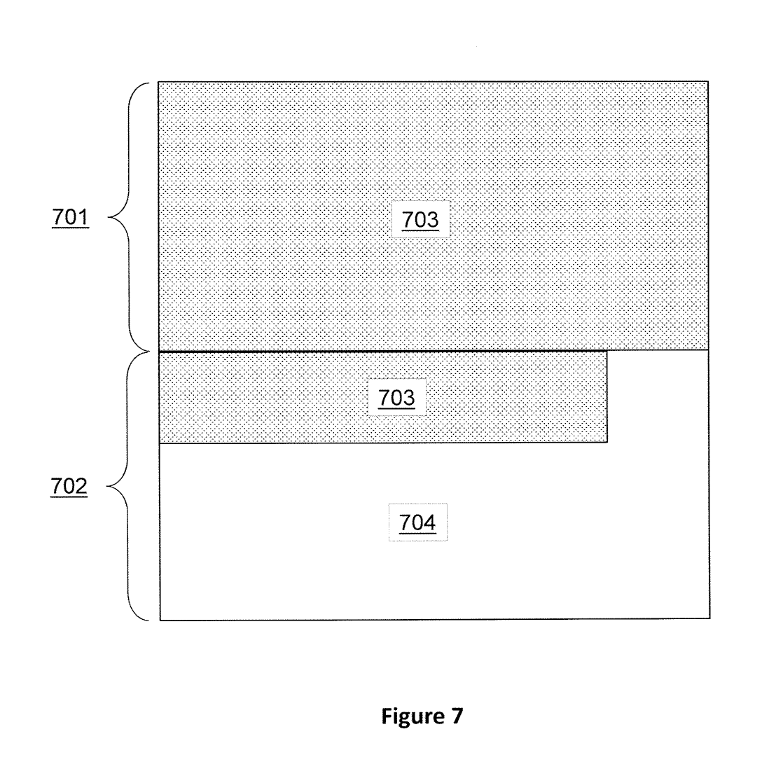

FIG. 7 illustrates an exemplary object being stored in two contiguous flash pages, according to one embodiment. Each of the two flash pages, 701 and 702, are 4 Kbytes in size. A data object 703, indicated by the diamond hatching, has a size greater than 4 Kbytes and is stored in two contiguous flash pages 701 and 702. The size of the object 703 is not a multiple of 4 Kbytes and there is unused space 704 left over in flash page 702. According to one embodiment, an OSD utilizes a table to keep track of the unused space between objects stored in contiguous flash pages. Keeping track of the unused space allows the OSD to insert smaller objects into the unused space prior to a flash page write. The OSD may retain additional meta-data in the object translation table, including the offset within the LBA where the object data resides.

Because data is typically written into a flash memory as one or more buffered pages, the firmware implementing the API for the OSD decides whether a buffered page should be written into the flash memory or held up in the buffer until some of the unused space has been filled with smaller objects. Heuristics formed from past object sizes may drive the decisions on what object sizes would fit in the remaining space of the buffered page and, in turn, drive the decisions on whether to write the buffered page to the flash memory or hold the data in the buffer.

According to one embodiment, an OSD implements object compression. Depending on the workload, the contents of certain objects are capable of being compressed considerably. Compressing highly compressible objects can improve many aspects of data storage, including: access latencies (e.g., if using hardware-accelerated compression), flash longevity, stability of performance, and object store storage efficiency (e.g., increase objects/GB).

If the object compression feature is enabled, the OSD may perform object compression dynamically using hardware. The object compression feature may be enabled globally (e.g., for all subsequent object insertions) or on a per-object-insertion basis. When the object compression feature is enabled, the OSD may retain additional metadata in the object translation table. The additional metadata may include the compressed length of the object. A zero value for the length indicates that the object was not compressed. If the length value is not zero, it may indicate the number of bytes that is provided to the decompressor when the object is requested for retrieval.

The global object compression setting may have three options: always on, always off, and dynamic. In the always off mode, no object compression is performed on incoming objects, and already compressed objects stored in the OSD are decompressed when being retrieved. In the always on mode, object compression is always performed. If the compressed data is larger than the original data, in which case compression failed, the OSD stores the original data. In the dynamic mode, the OSD compresses objects until it reaches a configurable threshold number of failed compressions.

According to one embodiment, an OSD implements object deduplication to prevent storing duplicate objects in the OSD, which advantageously increases the storage efficiency of the OSD. A user may enable the object deduplication feature globally or selectively during runtime. The OSD may implement object deduplication using a secondary hash lookup table to locate objects in the OSD with the same content. The OSD may use a second table to store the translation from hashes to objects.

When the OSD tests an object for duplication, the OSD computes a hash value for the object. The OSD looks up the hash value in the lookup table to locate other objects with the same hash value. Even if a matching object (e.g., object with the same hash value) is found, depending on the strength of the hash function, the OSD may perform a full comparison of the contents of the objects to ensure that the tested object and the matching object are indeed duplicates.

A first hash function is considered to be weaker than a second hash function if the first hash function has a greater chance of generating matching hash values from the contents of two different objects. Conversely, the first hash function is considered to be stronger if the first hash function has a lower chance of generating matching hash values from the contents of two different objects. Performing a full comparison of the tested object and the matching object may require the OSD to retrieve the contents of the matching object from the flash memory of the OSD. If the OSD determines that a duplicate of the tested object is already stored in the OSD, the tested object is not written to the flash memory. Instead, the OSD creates an entry in the second object translation to point to the LBA and increments the counter for that LBA.

According to one embodiment, an OSD ages its objects such that the objects expire in some amount of time. The OSD may offer two retention modes for storing workloads: persistent and ethereal. Persistent objects are accessible in the OSD for an indefinite period of time. Ethereal objects, on the other hand, are stored temporarily in the OSD and may expire due to demand for additional space or aging.

The retention mode of the OSD may be globally configurable by a user. When the retention mode is set or enabled, the OSD's object translation table keeps a timestamp with each object to track its usage. It also keeps a list of the least recently used (LRU) objects. When the OSD receives a request to store a new object (e.g., from a PUT operation) and there is no storage space available, the OSD behaves according to the selected retention mode. In the persistent mode, the PUT operation fails because the object cannot be stored without deleting objects already stored in the OSD. In the ethereal mode, the OSD deletes the LRU object(s) to make space available for storing the new object. Any access to an object refreshes the timestamp and moves it to the end of the LRU list.

The above example embodiments have been described hereinabove to illustrate various embodiments of implementing an object storage device on a computer main memory system. Various modifications and departures from the disclosed example embodiments will occur to those having ordinary skill in the art. The subject matter that is intended to be within the scope of the invention is set forth in the following claims.

What is claimed:

1. A system for implementing an object storage device comprising:
a first controller configured to interface with a main memory controller of a computer system to receive a data object and a first request for storing the data object, the first request including a key value; and
a second controller configured to:
allocate memory in one or more non-volatile memory storage units for storing the data object,
store the data object in the allocated memory, and
maintain an association between the key value and allocated memory.

2. The system of claim 1, wherein:
the first controller is further configured to receive a second request for retrieving the data object, the second request including the key value, and
the second controller is further configured to:
retrieve the data object from the allocated memory based on the key value and the association.

3. The system of claim 1, wherein:
the first controller is further configured to receive a third request for deleting the data object, the third request including the key value, and
the second controller is further configured to delete the data object from the allocated memory.

4. The system of claim 1, wherein to allocate memory includes allocating a plurality of memory locations for storing various portions of the data object.

5. The system of claim 4, wherein to maintain the association includes associating the key value with address values that correspond to the plurality of memory locations.

6. The system of claim 2, wherein to retrieve the data object includes:
searching for the association based on the key value,
determining the allocated memory based on the association, and
reading the data object from the allocated memory.

7. The system of claim 3, wherein to delete the data object includes:
searching for the association based on the key value,
deleting the association, and
de-allocating the allocated memory for subsequent use.

8. A method for implementing an object storage device comprising:
interfacing with a main memory controller of a computer system to receive a first request for storing a data object, the first request including a key value;
receiving the data object from the computer system;
allocating memory in one or more non-volatile memory storage units;
storing the data object in the allocated memory; and
maintaining an association between the key value and where the data object is stored.

9. The method of claim 8, further comprising:
receiving a second request for retrieving the data object, the second request including the key value, and
retrieving the data object from the allocated memory based on the key value and the association.

10. The method of claim 8, further comprising:
receiving a third request for deleting the data object, the third request including the key value, and
deleting the data object from the allocated memory.

11. The method of claim 8, wherein allocating memory includes allocating a plurality of memory locations for storing various portions of the data object.

12. The method of claim 11, wherein maintaining the association includes associating the key value with address values that correspond to the plurality of memory locations.

13. The method of claim 9, wherein retrieving the data object includes:
searching for the association based on the key value,
determining the allocated memory based on the association, and
reading the data object from the allocated memory.

14. The method of claim 10, wherein deleting the data object includes:
searching for the association based on the key value,
deleting the association, and
de-allocating the allocated memory for subsequent use.
